(19) United States
(12) Patent Application Publication
(10) Pub. No.: US 2025/0083383 A1
(43) Pub. Date: Mar. 13, 2025

(54) Diverter for a 3D Printer and a 3D Printer Using the Same

(71) Applicant: Ibossen R&D (Shenzhen) Co., Ltd., Guangdong (CN)

(72) Inventor: Huihui Fan, Guangdong (CN)

(73) Assignee: Ibossen R&D (Shenzhen) Co., Ltd., Guangdong (CN)

(21) Appl. No.: 18/465,152

(22) Filed: Sep. 11, 2023

(51) Int. Cl. B29C 64/209; B29C 64/295; B29C 64/321; B33Y 30/00

(52) U.S. Cl. CPC B29C 64/209; B29C 64/295; B29C 64/321; B33Y 30/00

(57) ABSTRACT

The present invention discloses a diverter for a 3D printer and a 3D printer using the same, comprising a heat conduit, a heating element provided on the outer periphery of the heat conduit, a diverter, and a nozzle provided below diverter, and a feeding channel is provided inside the heat conduit, and a throat is provided between the outlet of the feeding channel and the nozzle, the diverter disposed in the throat and the nozzle, the diverter also having a storage bin provided within the diverter for diverting and storing melted print material, the nozzle including an outlet, and when the print head assembly performs a printing operation, the melted print material stored within the storage compartment being discharged through the outlet.

### TECHNICAL FIELD

The present invention relates to the field of 3D printing technology, and in particular to a diverter shunt for a 3D printer and a 3D printer using it.

### BACKGROUND

3D printer is a very popular printing modeling equipment in recent years, and gradually promoted from the manufacturing field to life, in the 3D printer, the nozzle structure is mainly used to eject the printing material, which has been heated and melted, and printed layer by layer molding under the action of control equipment. Traditional 3D printers have a small storage space, can store less printing material, its printing speed is slow, cannot complete high-speed printing operations.

Patent EP3445568B1 discloses a 3D printer that uses a straight-through heater and increases the plastic melt rate by increasing the area of the heater wall, thereby increasing the printing speed. While this solution is effective in increasing the printing speed, it has a fixed capacity of the straight-through heater, which results in a fixed volume of plastic melted therein, and is unable to meet the demand for a large supply of hot-melted plastic when the printer is engaged in high-speed printing operations.

Based on the above problems, there is a need to propose a diverter for a 3D printer and a 3D printer using the same, the diverter for the 3D printer being effective in increasing the supply of hot melt plastic within the 3D printer, thereby increasing the speed of 3D printing.

### SUMMARY

The present invention provides a print head assembly for a 3D printer comprising a heat conduit, a heating element disposed at the outer periphery of the heat conduit, a diverter, and a nozzle disposed below said diverter.

Wherein the heat conduit is provided with a feeding channel inside the heat conduit, and there is a throat between the outlet of the feeding channel and the nozzle, the throat having a cylindrical inner wall surface, the diverter is provided in the throat.

The diverter having an upper end and a bottom end, the upper end being continuously formed toward the bottom end and forming a center column, the center column having a plurality of extension walls extending radially outward, the extension walls extending a length greater than the radius of the feeding channel, wherein each two adjacent the extension walls are at an angle to each other, and form a storage bin with a first inner wall surface.

The nozzle comprises an outlet, wherein the outlet has a radius less than the length over which the extension wall extends.

When the print material enters said feeding channel, said heating element carries out heating and transfers heat to the print material and melts it, and the melted print material is diverted through said shunt and stored in said storage bin, and when said print head assembly performs a print job, the melted print material stored in said storage bin is discharged through said outlet.

A print head assembly for a 3D printer comprising a heat conduit, a heating element provided at the outer periphery of the heat conduit, and a feeding channel provided inside the heat conduit, and a nozzle provided at the outlet of the feeding channel.

A print head assembly for a 3D printer comprising a heating element further comprising a diverter, the diverter comprising an upper end and a bottom end, wherein the upper end is continuously molded and formed into a center column in a direction toward the bottom end, the center column having a plurality of extension walls extending radially outwardly therefrom, the extension walls extending for a length greater than a radius of the feeding channel.

The nozzle has an outlet and a placement slot wherein the placement slot has a cylindrical second inner wall surface, the outlet having a radius less than the length of the extension wall extending.

Wherein the diverter is provided within the placement slot at an angle between every two adjacent the extension walls and forms a storage bin with a second inner wall surface of the placement slot.

When the print material enters said feeding channel, said heating element carries out heating and transfers heat to the print material and melts it, and the melted print material is diverted through said shunt and stored in said storage bin, and when said print head assembly performs a print job, the melted print material stored in said storage bin is discharged through said outlet.

A method of increasing the printing speed of a 3D printer comprising providing a diverter for a 3D printer, the diverter having a center column, and a plurality of extension walls extending radially outwardly from the center column, wherein the extension walls extend for a length that is greater than a radius of the feeding channel of 3D printer.

Setting the diverter in a feeding channel of the 3D printer, wherein the diverter forms a storage bin in the feeding channel.

Heating and melting the print material entering the feeding channel.

Guiding the printed material after melting through the diversion of the diverter into the storage bin.

The melted the print material stored in the storage bin is extruded out of the nozzle of the 3D printer and a 3D printing operation is performed.

A diverter for a 3D printer comprising a diverter body, the diverter body having a upper end and a bottom end, wherein the upper end is continuously molded and formed into a center column in a direction toward the bottom end, the center column having a plurality of extension walls extending outwardly in a radial direction, wherein each two adjacent the extension walls have an angle between them.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 shows a sectional view of the overall structural section of a print head assembly of a 3D printer;

FIG. 2 shows a sectional view of a print head assembly diverter of a 3D printer placed above a throat;

FIG. 3 shows a sectional view of a print head assembly diverter of a 3D printer;

FIG. 4 shows a sectional view of a print head assembly nozzle of a 3D poster;

FIG. 5 shows a schematic view of other structures of the print head assembly diverter of the 3D printer;

FIG. 6 shows a sectional view of a print head assembly diverter of a 3D printer placed within a nozzle;

FIG. 7 shows a sectional view of another nozzle of a print head assembly of a 3D printer.

In the drawings:

1000, print head assembly; 2000, heat conduit; 2001, heating element; 2002, feeding channel; 2003, connector; 2004, mounting base; 3000, diverter; 3001, upper end; 3002, bottom end; 3003, center column; 3004, extension wall; 3005, storage bin; 3006, outer edge; 4000, nozzle; 4001, throat; 4002, first inner wall surface; 4003, outlet; 4004, placement slot; 4005, connecting end; 4006, placement slot; 4007, second inner wall surface; 4008, tapered channel.

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

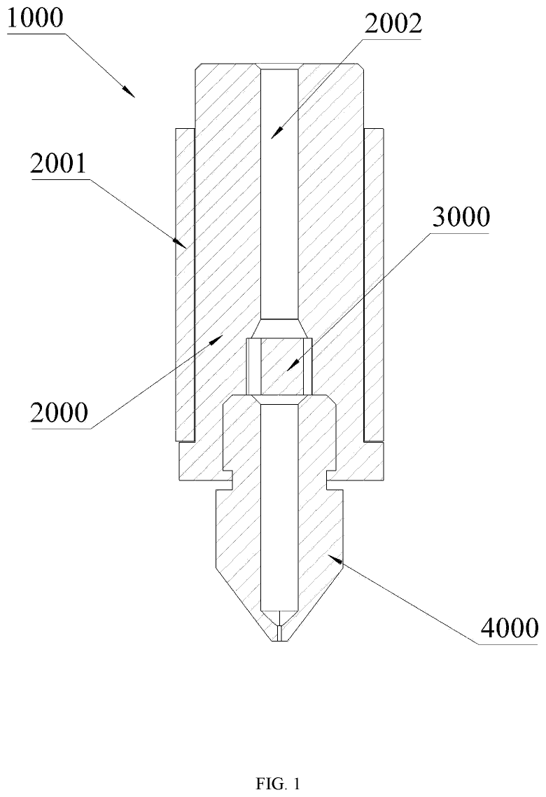

The present invention provides a print head assembly 1000 for a 3D printer, as shown in FIG. 1, comprising a heat conduit 2000, a heating element 2001 provided on the outer periphery of the heat conduit 2000, a diverter 3000, and a nozzle 4000 provided below the diverter 3000.

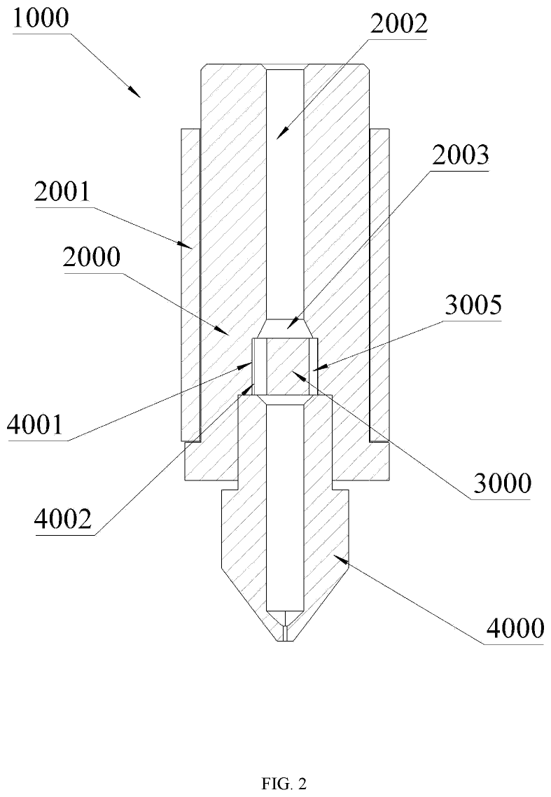

In this embodiment, as shown in FIG. 2, the heating element 2001 is in the form of a substantially hollow column structure, the heat conduit 2000 is threaded through the hollow column structure, and the inner end surface of the hollow column structure closely fits the outer wall surface of the heat conduit 2000, wherein the heat conduit 2000 is internally provided with a feeding channel 2002, the lower end of the feeding channel 2002 has a connector 2003, wherein the connector 2003 has a circular upper cross section and a circular lower cross section, wherein a radius of the circular upper cross section is less than a radius of the circular lower cross section, and the throat 4001 between the connector 2003 at the lower end of the feeding channel 2002, and the nozzle 4000, wherein the throat 4001 has a cylindrical first inner wall surface 4002.

In other embodiments (not shown in the figures), the heating element 2001 is configured as a plurality of curved pieces, the end surfaces of which closely fit the outer wall surface of the heat conduit 2000. In other embodiments (not shown in the figures), the connecting member at the lower end of the feeding channel 2002 may also be a hollow cylinder.

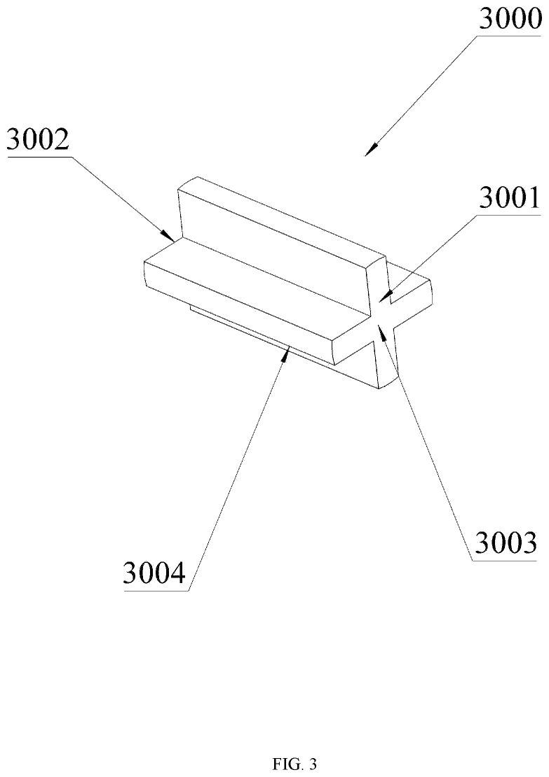

In this embodiment, the diverter 3000 is provided in the throat 4001, and as shown in FIG. 3, the diverter 3000 has an upper end 3001 and a bottom end 3002, wherein the upper end 3001 is continuously molded in the direction of wanting the bottom end 3002, and a center column 3003 is formed, wherein the center column 3003 extends outwardly along a radial direction with a plurality of extension walls 3004, the extension walls 3004 having a length greater than a radius of the feeding channel 2002, so that the melted print material can be smoothly transported from the feeding channel 2002 into the diverter 3000, thereby diverting the melted print material, and the diverter 3000 can also meter the melted print material, thereby accomplishing a higher-quality print job, which can effectively improve the success rate of the 3D printer.

In this embodiment, every two adjacent extension walls 3004 have an angle between them, and form a storage bin 3005 with the first inner wall surface 4002 of the throat 4001, so that the diverted hot melt printing material is stored in the storage bin 3005, wherein the storage bin 3005 has a sufficient amount of space for storing a sufficient amount of printing material, and sufficient hot melt material can be supplied during a printing operation, so as to be able to efficiently increase the printing speed.

In other embodiments (not shown in the figures), the distance between the upper end 3001 and the bottom end 3002 of the diverter 3000 can be any length. In other embodiments (not shown in the figures), the length of the extension wall 3004 may also be any length.

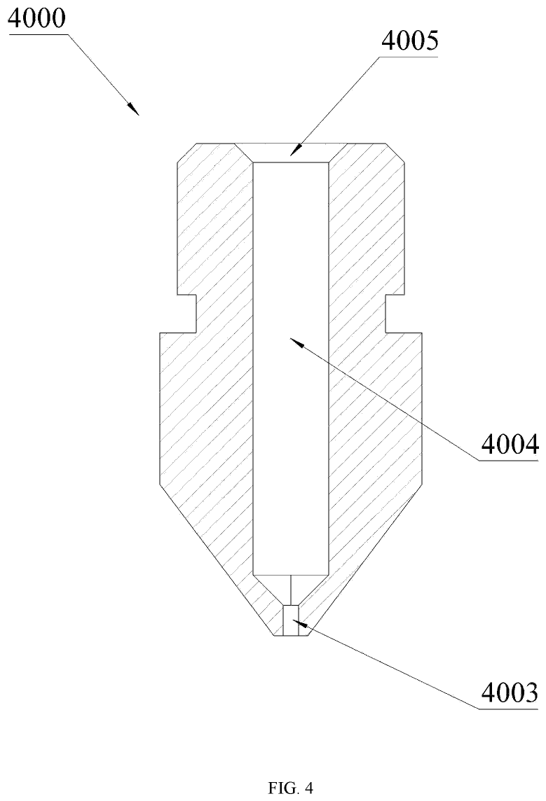

In this embodiment, as shown in FIG. 4, the nozzle 4000 comprises an outlet 4003, wherein the radius of the outlet 4003 is smaller than the extension length of the extension wall 3004, and a feed tube 4004 is connected above the outlet 4003, wherein the feed tube 4004 is provided with a connecting end 4005 at the upper end of the feed tube 4004, and the feed tube 4004 is connected to the diverter 3000 via the connecting end 4005 together. When the print head assembly 1000 performs a printing operation, the hot melt printing material stored in the storage bin 3005 is discharged through the outlet 4003 so as to perform the printing operation.

In this embodiment, the extension wall 3004 further has an outer edge 3006, wherein the outer edge 3006 has a curved surface, and the outer edge 3006 is in close abutment with the first inner wall surface 4002 of the throat 4001.

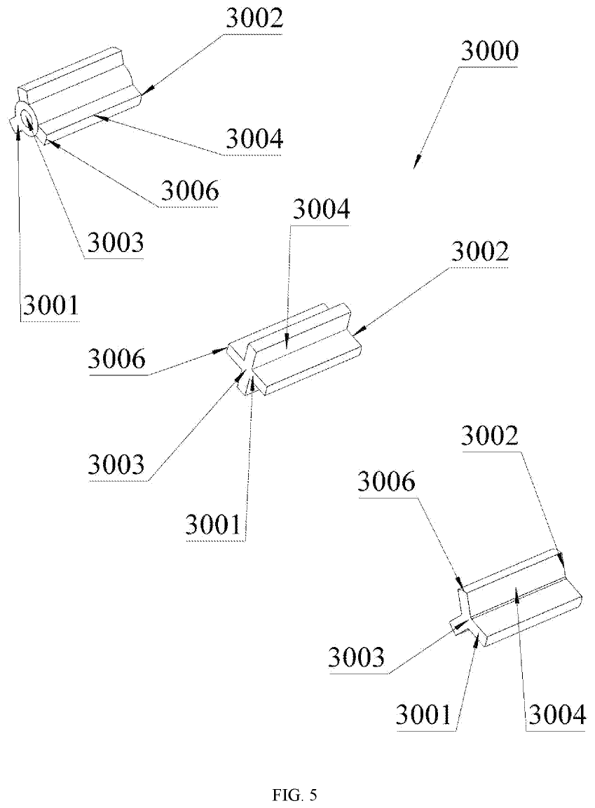

In this embodiment, as shown in FIG. 5, the number of extension walls 3004 are 4, wherein the angle between two adjacent extension walls 3004 is 90°. In this embodiment, the number of extension walls 3004 may also be 3, wherein the angle between two adjacent extension walls 3004 is 120°. In this embodiment, the center column 3003 is a hollow cylinder.

In other embodiments (not shown in the figures), the outer edge 3006 may also have a rectangular surface. In other embodiments (not shown in the figures), the number of extension walls 3004 can be any desired and the angle between two adjacent extension walls 3004 is 0°-180°. In other embodiments (not shown in the figures), the center column 3003 can also be prismatic, rectangular.

In this embodiment, the diverter 3000 is made of a high-temperature-resistant metal material, and by using the high-temperature-resistant metal material to manufacture the diverter 3000, it is able to withstand the heat and pressure of the printing process at high temperatures to ensure the printing quality and stability.

In other embodiments (not shown in the figures), the diverter 3000 may be made of tungsten metal Tungsten metal has good high temperature resistance, can maintain structural stability at high temperatures, can meet the requirements of high temperature printing processes, and does not cause contamination of the printed material. In other embodiments (not shown in the figures), the diverter 3000 may also be made of a platinum-rhodium alloy.

In other embodiments (not shown in the figures), the diverter 3000 may also be made of a silicon carbide ceramic material, which has a high thermal conductivity, good thermal conductivity, and stable chemical properties, and is capable of effectively improving the efficiency and success rate of 3D printing.

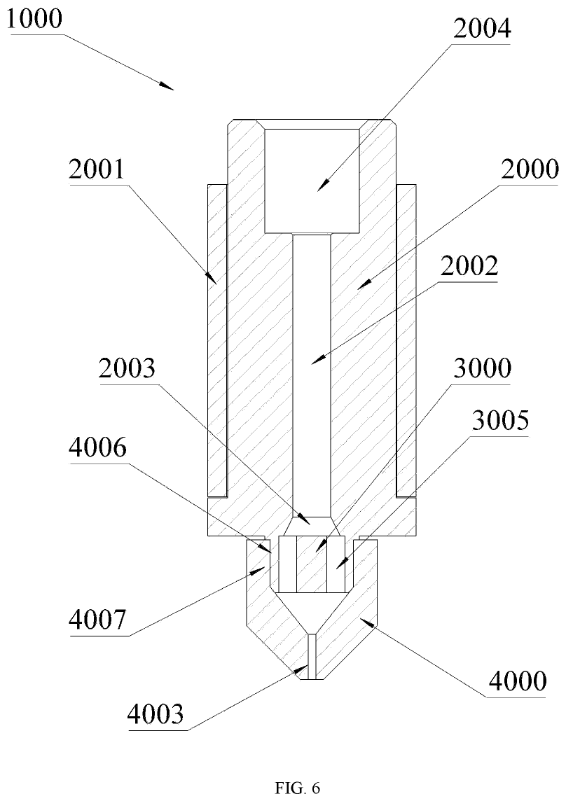

The present invention also provides a print head assembly 1000 for use in a 3D printer, as shown in FIG. 6, comprising a heat conduit 2000, a heating element 2001 disposed on the outer periphery of the heat conduit 2000, and a nozzle 4000 disposed at the outlet of the feeding channel 2002, wherein the heat conduit 2000 is internally disposed with a feeding channel 2002. The feeding channel 2002 has a mounting base 2004 at the upper end, wherein a through hole is provided at the lower end of the mounting base 2004 to be connected with the upper end of the feeding channel 2002 to facilitate the entry of printing material into the feeding channel 2002, the lower end of the feeding channel 2002 having a connector 2003, wherein the connector 2003 has a circular upper cross section and a circular lower cross section, wherein a radius of the circular upper cross section is smaller than a radius of the circular lower cross section, through the connector 2003.

Also included is a diverter 3000, wherein the diverter 3000 has a upper end 3001 and a bottom end 3002, wherein the upper end 3001 is continuously molded in the direction of wanting the bottom end 3002 and forms a center column 3003, wherein the center column 3003 has a plurality of extension walls 3004 extending outwardly along a radial direction, and wherein the length of the extension walls 3004 is greater than a radius of the feeding channel 2002 so that the print material can be smoothly conveyed from the feeding channel 2002 into the diverter 3000 without clogging.

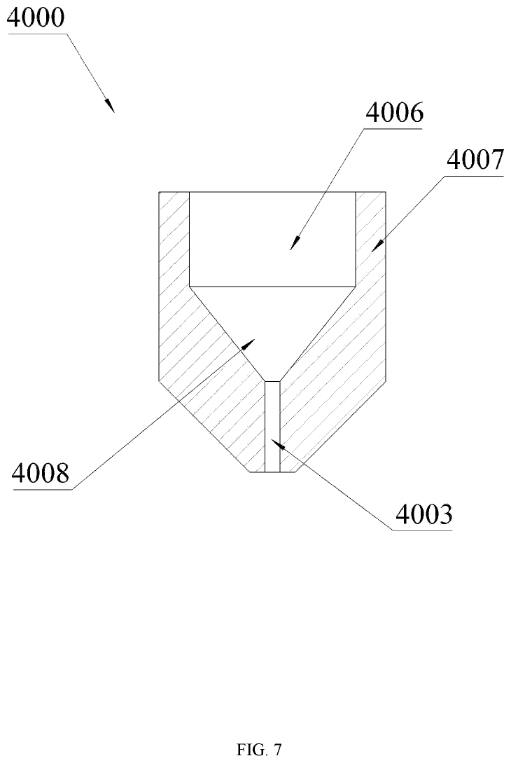

In this embodiment, as shown in FIG. 7, the nozzle 4000 has an outlet 4003 and a placement slot 4006, wherein the placement slot 4006 has a second inner wall surface 4007, wherein the second inner wall surface 4007 has a cylindrical surface, and wherein the radius of the outlet 4003 is less than the extension length of the extension wall 3004. In other embodiments (not shown in the figures), the second inner wall surface 4007 of the placement slot 4006 may also have a rectangular body surface.

In this embodiment, the diverter 3000 is provided inside the placement slot 4006, with an angle between every two adjacent extension walls 3004, and forms a storage bin 3005 with the second inner wall surface 4007 of the placement slot 4006; the storage bin 3005 is used for a sufficiently large storage space for storing a sufficient amount of hot-melt printing material, which in turn meets the supply of hot-melt plastics required by the printer at a high speed of printing, and ultimately improves the printing speed of the 3D printer.

In this embodiment, the extension wall 3004 has an outer edge 3006, wherein the outer edge 3006 closely abuts the second inner wall surface 4007 of the placement slot 4006.

In this embodiment, the nozzle 4000 is made of a high-temperature-resistant metal material that has good thermal and electrical conductivity and is capable of performing precise 3D printing operations.

In other embodiments (not shown in the figures), the nozzle 4000 may be made of a copper alloy material, which has good thermal and electrical conductivity, which makes the copper alloy nozzle 4000 a thermally sensitive material that is capable of performing precise 3D printing operations. In other embodiments (not shown in the figures), the nozzle 4000 may also be made of a nickel alloy material, which has high abrasion and corrosion resistance, and the use of the nozzle 4000 made of a nickel alloy may enable the 3D printer to provide stable performance under some extreme conditions. In other embodiments (not shown in the figures), the nozzle 4000 may also be made of an aluminum alloy material, which has a low density and excellent thermal conductivity properties that provide high printing efficiency in applications requiring light weight.

In this embodiment, the longitudinal depth of the placement slot 4006 is greater than half of the longitudinal height of the nozzle 4000, and there is also a tapered channel 4008 between the placement slot 4006 and the outlet 4003, wherein the diameter of the tapered channel 4008 decreases in the direction of the outlet 4003, so as to realize that the outflow of the hot-melt printing material can be controlled during the 3D printing operation, and to accomplish a more accurate printing operation. In other embodiments (not shown in the figures), the tapered channel 4008 may also be provided between the placement slot 4006 and the outlet 4003.

The present invention also provides a method of increasing the printing speed of a 3D printer, comprising providing a diverter 3000 for a 3D printer, the diverter 3000 having a center column 3003, and a plurality of extension walls 3004 extending radially outward from the center column 3003, wherein the extension walls 3004 extend for a length that is greater than a radius of the feeding channel 2002 of the 3D printer.

The diverter 3000 is provided in the feeding channel 2002 of the 3D printer, wherein the diverter 3000 forms a storage bin 3005 in the feeding channel 2002.

The print material enters the heating element 2001 through the feeding channel 2002 to be heated and melted, and the melted print material enters the diverter 3000 to be diverted, and the melted print material is stored in the storage bin 3005, and when the printing operation is performed, the print material stored in the storage bin 3005 is extruded through extrusion from the outlet 4003 on the nozzle 4000 of the 3D printer, so as to perform the printing operation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A print head assembly for a 3D printer comprising:
a heat conduit, a heating element provided on the outer periphery of the heat conduit, a diverter, and a nozzle provided below said diverter; and
wherein said heat conduit is internally provided with a feeding channel, wherein said feeding channel has a throat between the outlet of said feeding channel and said nozzle, said throat having a cylindrical first inner wall surface; and
said diverter is provided in said throat, said diverter having an upper end and a bottom end, said upper end being continuously formed toward said bottom end and forming a center column, said center column having a plurality of extension walls extending radially outward, said extension walls extending a length greater than the radius of said feeding channel, wherein each two adjacent said extension walls are at an angle to each other, and form a storage bin with a first inner wall surface; and
said nozzle comprises an outlet, wherein said outlet has a radius less than the length over which said extension wall extends; and
when the print material enters said feeding channel, said heating element carries out heating and transfers heat to the print material and melts it, and the melted print material is diverted through said shunt and stored in said storage bin, and when said print head assembly performs a print job, the melted print material stored in said storage bin is discharged through said outlet.

2. A print head assembly for a 3D printer according to claim 1, wherein, said extension wall has an outer edge, said outer edge being in close abutment with a first inner wall surface of said throat.

3. A print head assembly for a 3D printer according to claim 2, wherein, the number of said extension walls are 3.

4. A print head assembly for a 3D printer according to claim 2, wherein, the number of said extension walls are 4.

5. A print head assembly for a 3D printer according to claim 3, wherein, the angle between two adjacent said extension walls is 120°.

6. A print head assembly for a 3D printer according to claim 4, wherein, the angle between two adjacent said extension walls is 90°.

7. A print head assembly for a 3D printer according to claim 5, wherein, said center column is a hollow cylinder.

8. A print head assembly for a 3D printer according to claim 1, wherein, said diverter is made of a high temperature resistant material.

9. A print head assembly for a 3D printer comprising:
a heat conduit, a heating element provided on the outer periphery of the heat conduit, a feeding channel provided inside the heat conduit, and further comprising a nozzle provided at the outlet of said feeding channel; and
wherein further comprising a diverter, said diverter comprising an upper end and a bottom end, wherein said upper end is continuously molded and formed into a center column in a direction toward said bottom end, said center column having a plurality of extension walls extending radially outwardly therefrom, said extension walls extending for a length greater than a radius of said feeding channel; and
said nozzle has an outlet and a placement slot wherein said placement slot has a cylindrical second inner wall surface, said outlet having a radius less than the length of said extension wall extending; and
wherein said diverter is provided within said placement slot at an angle between every two adjacent said extension walls and forms a storage bin with a second inner wall surface of said placement slot; and
when the print material enters said feeding channel, said heating element carries out heating and transfers heat to the print material and melts it, and the melted print material is diverted through said shunt and stored in said storage bin, and when said print head assembly performs a print job, the melted print material stored in said storage bin is discharged through said outlet.

10. A print head assembly for a 3D printer according to claim 9, wherein, said extension wall has an outer edge, said outer edge being in close fit with a second inner wall surface of said placement slot.

11. A print head assembly for a 3D printer according to claim 10, wherein, said nozzle 4000 is made of metal.

12. A print head assembly for a 3D printer according to claim 11, wherein, the longitudinal depth of said placement slot is greater than half of the longitudinal height of said nozzle.

13. A print head assembly for a 3D printer according to claim 12, wherein, said placement slot has a tapered channel between said placement slot and said outlet, said tapered channel having a decreasing diameter in the direction of said outlet.

14. A method of increasing the printing speed of a 3D printer comprising a diverter for a 3D printer, said diverter having a center column, and a plurality of extension walls extending radially outwardly from said center column, wherein said extension walls extend for a length that is greater than a radius of said feeding channel of 3D printer; and
setting said diverter in a feeding channel of said 3D printer, wherein said diverter forms a storage bin in said feeding channel; and
heating and melting the print material entering said feeding channel; and
guiding said printed material after melting through said diversion of the diverter into said storage bin; and
the melted said print material stored in said storage bin is extruded out of the nozzle of said 3D printer and a 3D printing operation is performed.

15. A method of increasing the printing speed of a 3D printer according to claim 14, wherein, said extension wall extends for a length greater than a radius of a nozzle of said 3D printer.

16. A diverter for a 3D printer comprising a diverter body, said diverter body having an upper end and a bottom end, wherein said upper end is continuously molded and formed into a center column in a direction toward said bottom end, said center column having a plurality of extension walls extending outwardly in a radial direction, wherein each two adjacent said extension walls have an angle between them.

17. A diverter for a 3D printer according to claim 16, wherein, the number of said extension walls are 3.

18. A diverter for a 3D printer according to claim 17, wherein, the angle between two adjacent said extension walls is 120°.

19. A diverter for a 3D printer according to claim 18, wherein, said center column is a hollow cylinder.

20. A diverter for a 3D printer according to claim 19, wherein, said diverter is made of a high temperature resistant material.
